(19) United States
(12) Patent Application Publication
(10) Pub. No.: US 2018/0218357 A1
(43) Pub. Date: Aug. 2, 2018

(54) EXPORT HIGH VALUE MATERIAL BASED ON RING 1 EVIDENCE OF OWNERSHIP

(71) Applicant: MICROSOFT TECHNOLOGY LICENSING, LLC, Redmond, WA (US)

(72) Inventors: Tolga Acar, Sammamish, WA (US); Matthias Bernard Pisut, IV, Issaquah, WA (US); Malcolm Erik Pearson, Kirkland, WA (US)

(21) Appl. No.: 15/610,858

(22) Filed: Jun. 1, 2017

Related U.S. Application Data
(60) Provisional application No. 62/453,360, filed on Feb. 1, 2017.

(51) Int. Cl. G06Q 20/32; H04L 9/32; G06Q 20/36

(52) U.S. Cl. CPC G06Q 20/3227; G06Q 20/3672; G06Q 20/3674; H04L 9/3213

(57) ABSTRACT

A mechanism to export a payment instrument from a secured database to a user device based on a binding between the user device and an identifier associated with the owner of the payment instrument. A computing system performs the following: binds a device ID that is associated with a user device to a user ID that is associated with an owner of a payment instrument and records a representation of the binding in a secured database; generates an identifier that signifies that the user device that is associated with the device ID has been granted permission to export payment instrument information; returns the identifier to the user device; receives from the user device a payload that includes the identifier, the user ID, and the device ID; and exports an encrypted version of the payment instrument information to the user device.

### CROSS-REFERENCE TO RELATED APPLICATIONS

This application claims the benefit of and priority to U.S. Provisional Patent Application Ser. No. 62/453,360 filed on Feb. 1, 2017 and entitled “EXPORT HIGH VALUE MATERIAL BASED ON RING1 EVIDENCE OF OWNERSHIP,” which application is expressly incorporated herein by reference in its entirety.

### BACKGROUND

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been, and are being, developed in all shapes and sizes with varying capabilities. As such, many individuals and families alike have begun using multiple computer systems throughout a given day.

For instance, computer systems are now used in ecommerce and the like as individuals increasing perform financial transactions such as making a purchase from various vendors over the Internet. In order to perform the financial transactions, the individuals are typically required to provide a payment instrument such as a credit card or bank account information such as a checking account to the vendor over the Internet. The vendor then uses the payment instrument to complete the transaction.

The process of providing the payment instrument over the Internet leaves the payment instrument vulnerable to being stolen by malicious parties. This has led to the creation of various security methods such as encryption to help to protect the payment instrument as it is being transported. However, the malicious parties are increasing sophisticated in their efforts to steal the payment instruments. Accordingly, there is a constant need to update the security methods that are implemented to prevent the malicious parties from gaining access to the payment instruments.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments disclosed herein are related to systems, methods, and computer readable medium for implementing a mechanism to export a payment instrument from a secured database to a user device that is controlled by an owner of the payment instrument based on a binding between the user device and an identifier associated with the owner of the payment instrument at the secured database. In one embodiment, a computing system includes a processor and system memory that stores computer-executable instructions. When the executable instructions are executed by the processors, the computing system binds a device ID that is associated with a user device to a user ID that is associated with an owner of a payment instrument and records a representation of the binding in a secured database. The computing system generates an identifier that signifies that the user device that is associated with the device ID has been granted permission to export payment instrument information. The payment instrument information is associated with the user ID in the secured database. The computing system returns the identifier to the user device. The computing system receives from the user device a payload that includes at least the identifier, the user ID, and the device ID. The computing system exports an encrypted version of the payment instrument information to the user device upon determining that the identifier, the user ID, and the device ID match the identifier, the user ID, and the device ID stored at the secure database.

Another embodiment disclosed herein relates to a user device that communicates with a payment computing system for exporting an encrypted payment instrument when the user device is beyond the control of the payment computing system. In one embodiment, the user device includes a processor and system memory that stores computer-executable instructions. When the executable instructions are executed by the processors, the user device receives an identifier that signifies that the user device has been granted permission to export payment instrument information from a payment computing system. The payment instrument information is associated with a user ID and a user device ID in a secured database of the payment computing system. The user device generates a payload that includes at least the identifier, the user ID, and the device ID. The user device receives an encrypted version of the payment instrument information from the payment computing system when it is determined that the identifier, the user ID, and the device ID in the payload match the identifier, the user ID, and the device ID stored at the secure database.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example computing system in which the principles described herein may be employed;

FIG. 2 illustrates a computing environment that may implement the embodiments disclosed herein;

FIGS. 3A-3C illustrate a process for adding a payment instrument to a store according to the embodiments disclosed herein;

FIG. 4 illustrates an embodiment of binding devices to user identities in a store according to the embodiments disclosed herein;

FIGS. 5A-5B illustrates a process for exporting a payment instrument from a store according to the embodiments disclosed herein;

FIG. 6 illustrates a flow chart of an example method for exporting a payment instrument from a secured database to a user device that is controlled by an owner of the payment instrument; and

FIG. 7 illustrates a flow chart of an example method for a user device to communicate with a payment computing system for exporting an encrypted payment instrument when the user device is outside the control of the payment computing system.

### DETAILED DESCRIPTION

Embodiments disclosed herein are related to systems, methods, and computer readable medium for implementing a mechanism to export a payment instrument from a secured database to a user device that is controlled by an owner of the payment instrument based on a binding between the user device and an identifier associated with the owner of the payment instrument at the secured database. In one embodiment, a computing system includes a processor and system memory that stores computer-executable instructions. When the executable instructions are executed by the processors, the computing system binds a device ID that is associated with a user device to a user ID that is associated with an owner of a payment instrument and records a representation of the binding in a secured database. The computing system generates an identifier that signifies that the user device that is associated with the device ID has been granted permission to export payment instrument information. The payment instrument information is associated with the user ID in the secured database. The computing system returns the identifier to the user device. The computing system receives from the user device a payload that includes at least the identifier, the user ID, and the device ID. The computing system exports an encrypted version of the payment instrument information to the user device upon determining that the identifier, the user ID, and the device ID match the identifier, the user ID, and the device ID stored at the secure database.

Another embodiment disclosed herein relates to a user device that communicates with a payment computing system for exporting an encrypted payment instrument when the user device is beyond the control of the payment computing system. In one embodiment, the user device includes a processor and system memory that stores computer-executable instructions. When the executable instructions are executed by the processors, the user device receives an identifier that signifies that the user device has been granted permission to export payment instrument information from a payment computing system. The payment instrument information is associated with a user ID and a user device ID in a secured database of the payment computing system. The user device generates a payload that includes at least the identifier, the user ID, and the device ID. The user device receives an encrypted version of the payment instrument information from the payment computing system when it is determined that the identifier, the user ID, and the device ID in the payload match the identifier, the user ID, and the device ID stored at the secure database.

There are various technical effects and benefits that can be achieved by implementing aspects of the disclosed embodiments. By way of example, it is now possible to securely bind a user device to a payment instrument or to other types of sensitive data. In addition, it is now possible to securely bind the payment instrument or another type of sensitive data to a number of user devices that are controlled by the owner of the payment instrument based on the secure binding. Moreover, it is possible to limit the amount of computing devices in the payment system that are required to be compliant with payment instrument standards. The embodiments disclosed herein also provide for the technical effect of transporting a token as an identifier for data so that the data does not need to be transported across a non-secured portion of a computing system. Further, the technical effects related to the disclosed embodiments can also include improved user convenience and efficiency gains.

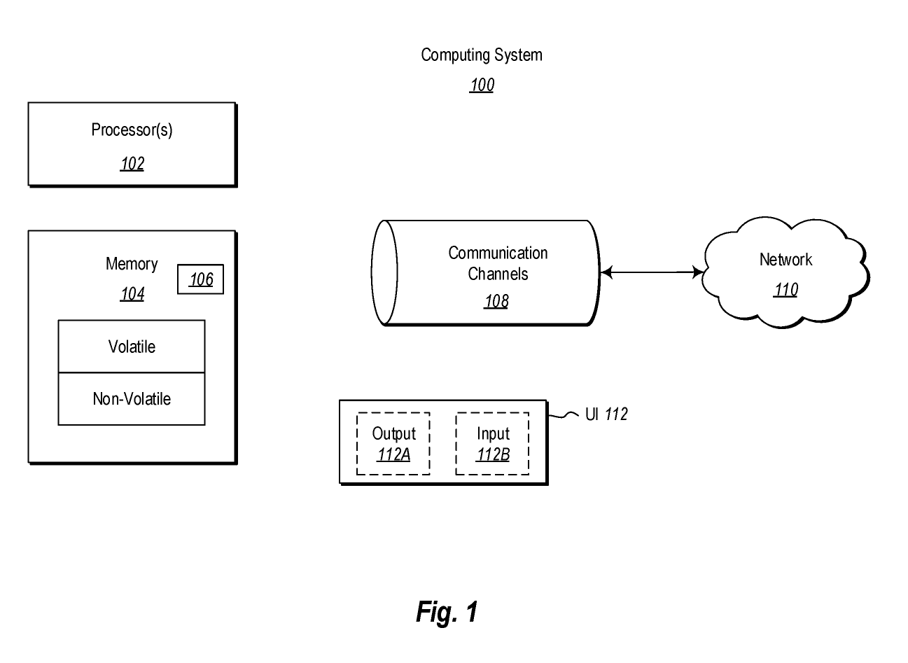

Some introductory discussion of a computing system will be described with respect to FIG. 1. Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface system 112 for use in interfacing with a user. The user interface system 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

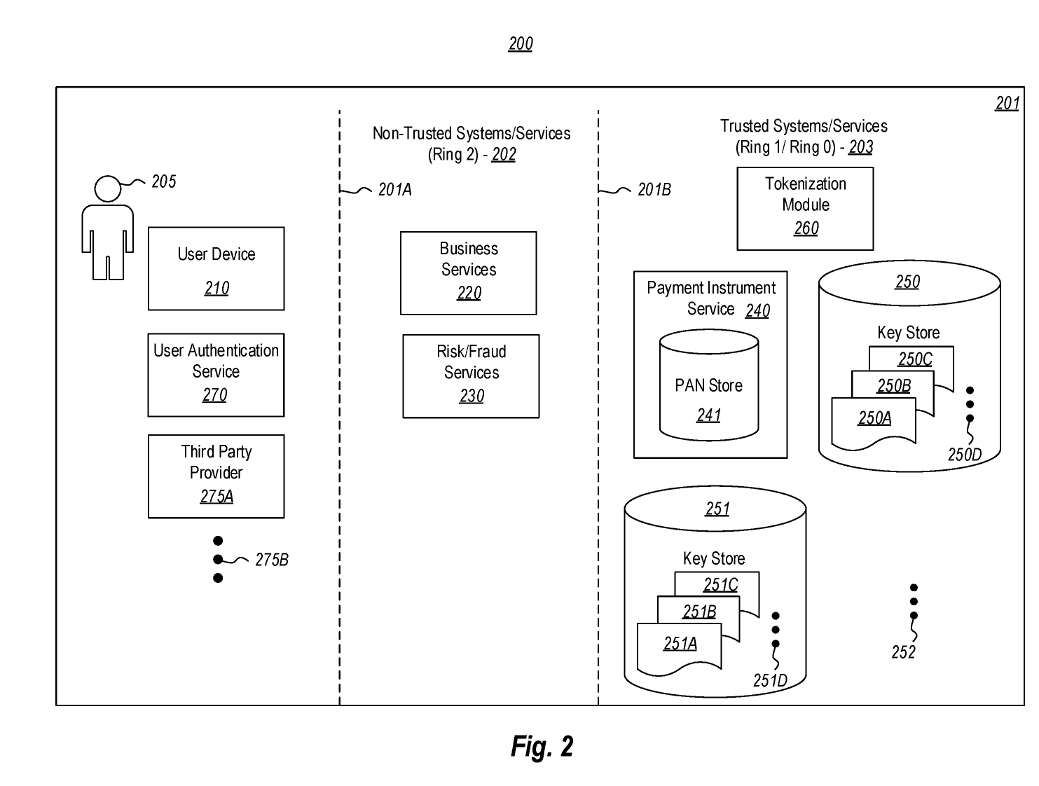

Attention is now given to FIG. 2, which illustrates an embodiment of computing environment 200 including a computing system, which may correspond to the computing system 100 previously described. The computing environment 200 includes various components or functional blocks that may implement the various embodiments disclosed herein as will be explained. The various components or functional blocks of computing environment 200 may be implemented on a local computing system or may be implemented on a distributed computing system that includes elements resident in the cloud or that implement aspects of cloud computing. The various components or functional blocks of the computing environment 200 may be implemented as software, hardware, or a combination of software and hardware. The computing environment 200 may include more or less than the components illustrated in FIG. 2 and some of the components may be combined as circumstances warrant. Although not necessarily illustrated, the various components of the computing environment 200 may access and/or utilize a processor and memory, such as processor 102 and memory 104, as needed to perform their various functions.

As illustrated in FIG. 2, the computing environment 200 may include a user device 210 that is used by a user 205 to perform various financial transactions such as purchasing items or services from a third party provider 275A and/or from any number of additional third party providers as illustrated by the ellipses 275B. The user device 210 may be a desktop computer, a laptop computer, a mobile phone or other mobile computing device, a smart phone, or any other reasonable computing device. The user device 210 may also be a distributed device. When performing the various financial transactions, the user device 210 may utilize a payment instrument such as a credit card, debit card, electronic check, bank account such as a checking or savings account, or any other type of recognized financial device belonging to or otherwise associated with the user 205 that may be used to complete the transaction. In embodiments to be disclosed in more detail, the user 205 may provide a Primary Account Number (PAN) for the payment instrument to a payment service 201 for storage and use in completing the transaction. In the embodiments disclosed herein the PAN may be a credit card number, a debit card number, a bank account number, or any other financial or bank account information as specified by the type of payment instrument. Thus, the embodiments disclosed herein are not limited by the type of PAN. It will be noted that a PAN is an example of payment instrument information. Although the embodiments disclosed herein use a PAN as a primary example, the embodiments also relate to other types of sensitive data. Sensitive data is any data that should be kept private and should be protected from widespread distribution. In addition to the financial devices discussed above, sensitive data may include data such as personal identification information and the like.

In some embodiments, the computing environment 200 may also include a user authentication service 270 that is associated with the third party provider 275A and/or the user device 210 and thus may not be part of the payment service 201. In other embodiments, the authentication service 270 may be associated with the payment service 201, may be federation of related systems, may be associated with both the third party provider 275A and the payment service 201, or any combination of these as circumstances warrant. As will be explained in more detail to follow, the user authentication service 270 may be utilized by the payment service 201 to provide authentication and identification of the user 205 and/or the user device 210.

The environment 200 may also include the payment service 201, which is shown to the right of the dashed line 201A. As illustrated, the payment service 201 may include non-trusted systems/services 202, which are shown between dashed lines 201A and 201B. The non-trusted systems/services 202 are non-trusted because the owner of the payment system 201 generally takes less effort to secure these systems so that more effort may be taken to secure the trusted systems and services. Accordingly, the non-trusted systems/services 202 are more susceptible to malicious attackers who may desire to gain access to the payment instrument of the user 205. The non-trusted systems/services 202 may be located in Ring2 or higher of a computing system hierarchical protection ring system. In embodiments to be discussed in more detail to follow, the non-trusted systems/services 202 may not be considered as being compliant with the security standards required by a standards setting body such as the Payment Card Industry (PCI). In other words, the non-trusted systems/services 202 do not need to be PCI compliant. It will be appreciated, however, that according to the PCI standards the non-trusted systems/services 202 are not required to be PCI compliant as long as the overall payment system 201 is PCI compliant.

The non-trusted systems/services 202 may include various business services 220 that is used by payment system 201 such as transportation and other related services. Accordingly, the business services 220 may represent any system or service used by the payment system 201. The non-trusted systems/services 202 may also include various risk/fraud services 230 that are used by the payment system 201 to provide authentication and fraud detection services as needed. Accordingly, the embodiments disclosed herein are not limited by the number or type of the non-trusted systems/services 202.

The payment system 201 may also include trusted systems/services 203, which are shown to the right of the dashed line 201B. The trusted systems/services are trusted because they include security that makes them secure from the malicious attackers. The trusted systems/services 203 may be located in Ring1 or Ring 0 of the computing system hierarchical protection ring system. In embodiments to be discussed in more detail to follow, the trusted systems/services 203 may be considered as being PCI compliant since they comply with the PCI standards, thus making the overall payment system 201 PCI compliant. It will be noted that although the figures show all of the trusted systems/services 203 as being to the right of the dashed line 201B, this is for ease of illustration only. Thus, in some embodiments portions of the trusted systems/services 203 may be located in other portions of the system outside of Ring1 or Ring 0 as long as they are properly isolated and secured.

The trusted systems/services 203 may include a payment instrument service 240 that includes a PAN or other bank account information store 241. Since the embodiments disclosed herein often discuss use of a PAN, the store 140 will typically be referred to as PAN store 240, even though it may also store other bank information as well. As will be explained in more detail to follow, the PAN store 241 is used to store an encrypted or otherwise protected version of the PAN that may then be returned to the user device 210 as needed to complete financial transactions. A key store 250 may also be included that may store various encryption keys 250A, 250B, 250C, and any number of additional keys as illustrated by ellipses 250D that are used to encrypt a PAN received from the user device 210.

In some embodiments, an additional key store 251 and any number of additional key stores as illustrated by the ellipses 252 may also be included. This may include federation systems that allow for different implementations of key stores due to different generations of technology or to merging of accounts and the like when existing payment services or other services are combined. The key store 251 may include various encryption keys 251A, 251B, 251C, and any number of additional keys as illustrated by ellipses 251D that may be used to further encrypt the PAN received from the user device 210. In such embodiments, as will be explained in more detail to follow, the keys 251A-251D may be keys that are specific to a given device such as user device 210. It will noted that in some embodiments, the key stores 250-252 be part of the payment instrument service 240.

The trusted systems/services 203 may further include a tokenization module 260. The tokenization module 260 may provide a token that represents the PAN and other sensitive information. Since the tokenization module 260 will only provide the PAN and other sensitive information to systems and services that are part of the trusted systems/services 203 that provide it with the token, the PAN and other sensitive information need not be transmitted by or otherwise be accessible to the business logic 220, the risk/fraud services 230, or any other system or service that is outside of the trusted system/services 203. The tokenization operation will be described in more detail to follow.

### Add Payment Instrument Flow

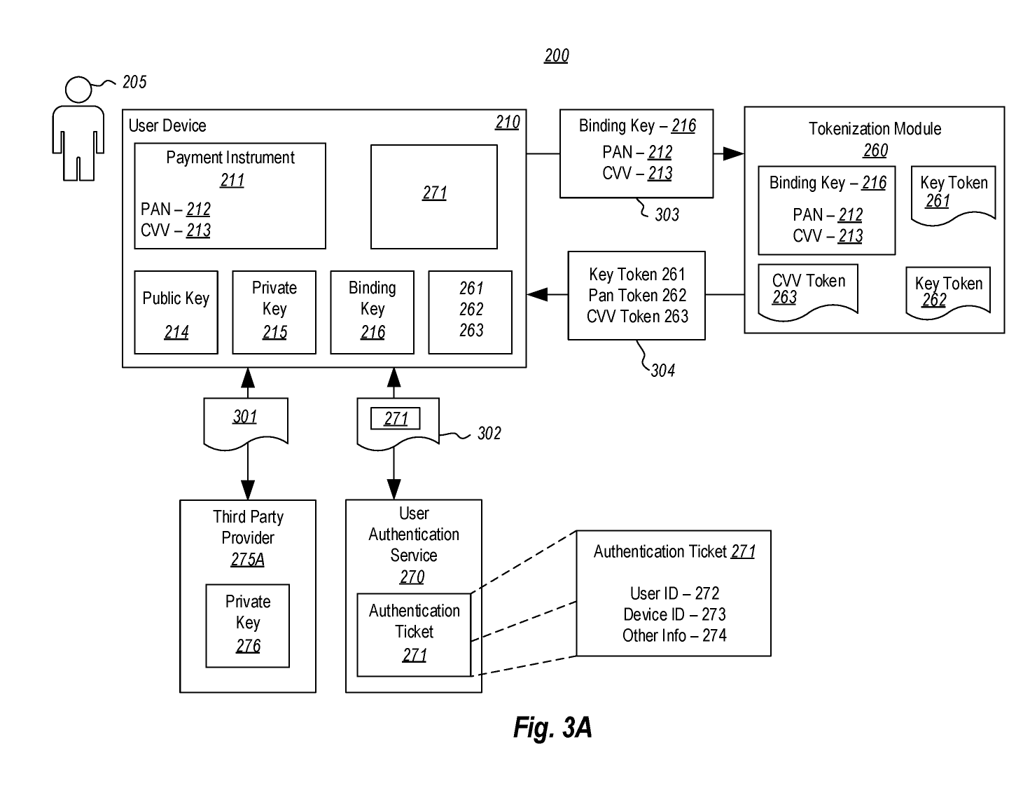

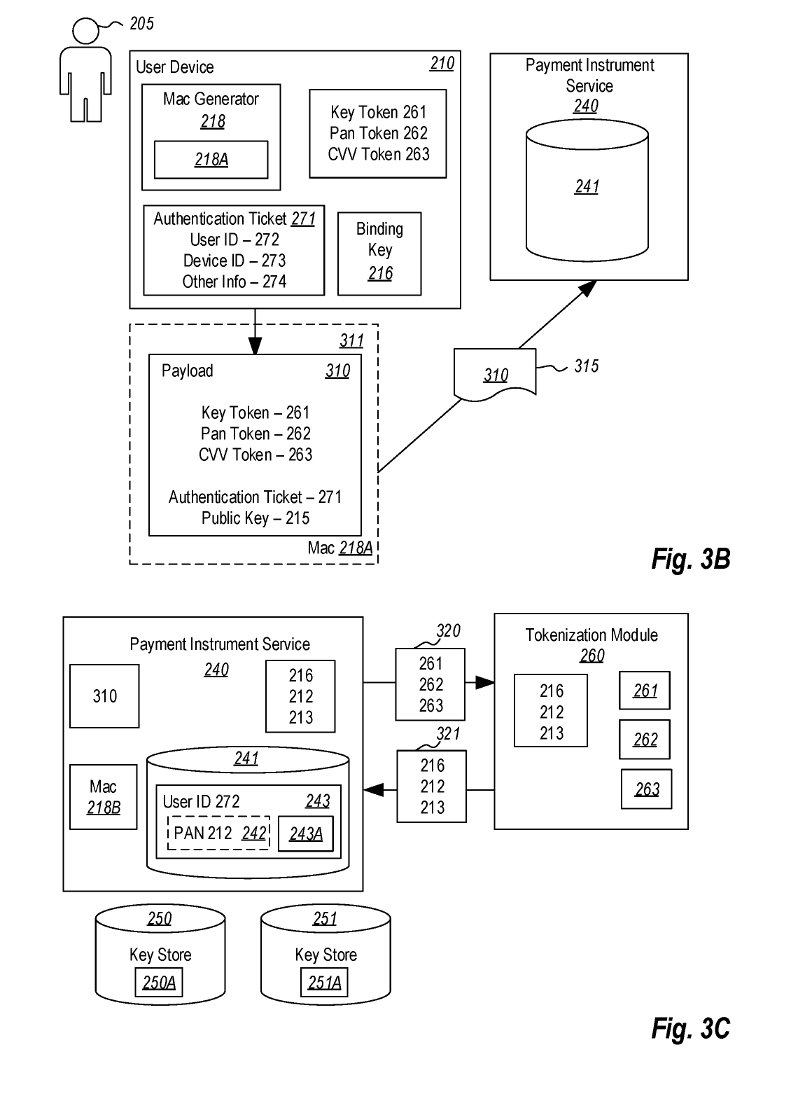

A specific embodiment of adding a payment instrument such as a credit card to the PAN store 241 using the tokenization information will now be explained. The embodiment will be described in relation to FIGS. 3A-3C. It will be noted that for ease of explanation, FIGS. 3A-3C will include only those elements of FIG. 2 that are necessary for explanation. The payment instrument may be added to the PAN store 241 in response to the user initiating a transaction or because the user 205 may decide to store the payment instrument for future use.

As shown in FIG. 3A, in the specific embodiment the user 205 may initiate a transaction with the third party provider 275A to purchase an item and/or a service using a payment instrument 211 having a PAN 212 and a Card Verification Value (CVV) 213 (or other type of verification information such as an SMS delivered one time password, secret answers, other passwords, or the like) as shown at 301. It will be noted that the CVV 213 and other types of verification are examples of payment instrument information. The payment instrument 211 may be a credit card or a debit card, the PAN 212 may be a credit or debit card number, and the CVV 213 may be the typical three or four digit code associated with the credit or debit card. The payment instrument 211 need not be a credit or debit card, but may be any other reasonable payment instrument. In those embodiments where the payment instrument 211 is something different than a credit or debit card, the PAN 212 may be an account number that is associated with the payment instrument and the CVV 213 may correspond to a security element appropriate for the type of payment instrument or there may be no equivalent to the CVV 213. Of course, the payment instrument may include information in addition to the PAN 212 and the CVV 213. Accordingly, the embodiments disclosed herein are not limited by the type of payment instrument 211 or to a particular PAN 212 and/or CVV 213

During the transaction 301, the third party provider 275A may request the payment instrument 211 information from the user device 210. Accordingly, the user 205 may enter the PAN 212 and CVV 213, and other information such as a billing address into the user device 210. An authentication service 270, which may be associated with the third party provider 275A and/or the user device 210, may then authenticate the identity of the user 205 and the user device 210. As will be explained in further detail to follow, this user authentication is used by the payment service 201 to store and retrieve payment instrument information.

As illustrated, in some embodiments the user authentication service may generate an authentication ticket 271 as part of the authentication process. The authentication ticket 271 may include a user ID 272 such as a user name, address, or the like that identifies the user 205, a device ID 273 that identifies the user device 210, and other information 274 as needed. The authentication ticket 271 may be secured using known security methods such as Transport layer security (TLS). The authentication ticket 271 may be returned to the user device 210 as shown at 302.

The user device 210 may generate a binding key 216 that may be used in the tokenization process. In one embodiment, the binding key 216 may be an ephemeral (i.e., short term, one time use), random, cryptographically strong, symmetric key, 128 bits long. Of course, the binding key 216 need not be 128 bits long as it may also be more or less bits as circumstances warrant. In other embodiments other reasonable binding keys may be generated as circumstances warrant. The binding key 216 may only be known to the user device 210, which advantageously prevents it from being accessible by the systems and services in non-trusted systems/services 202. In addition, since the binding key 216 may be a short term, one time use key, if the key is compromised in any way, it will only be able to be used in a malicious manner for a single session, thus limiting any harm that the compromise may cause.

The user device 210 may then send the binding key 216, the PAN 212, and the CVV 213 to the tokenization module 260 as shown at 303, either directly or through a secured communication channel, such as an encrypted channel. Since the user device 210 is able to communicate with the tokenization module 260, there is no interaction with the systems and services in non-trusted systems/services 202. The tokenization module 260 may receive and store the binding key 216, the PAN 212, and the CVV 213 in a secured memory. In addition, the tokenization module 260 may generate a token or identifier 261 for the binding key 216, a token or identifier 262 for PAN 212, and a token or identifier 263 for CVV 213. The tokens or identifiers 261, 262, and 263 are a randomly generated number of bits that may cryptographically secured that are used to indicate that the possessor of the token or identifiers has a right to access the binding key 216, PAN 212, and the CVV 213 that is stored by the tokenization module 260.

The tokenization module 260 may then return the key token 261, the PAN token 262, and the CVV token 263 to the device 210 as shown at 304. These tokens may be temporarily stored by the user device 210.

In some embodiments, the user device 210 may include a public key 214 and a private key 215 pair. As will be explained in more detail to follow, the public key 214 may be used to encrypt the PAN 212 when being returned from the payment instrument service 240 to the user device 210. In such embodiments, the private key 215 may be used to decrypt the decrypted PAN. In other embodiments, a private key 276 that is associated with the third party provider 275A may be used useable by the user device 210 in conjunction with the public key 214 to encrypt and decrypt. In still other embodiments, other private keys that are associated with one or more of the third party providers 275B may also be used. In other words, the private key may be controlled by or associated with the user device 210 or may be controlled by or associated with a third party that the user device 210 is acting on behalf of.

Referring now to FIG. 3B, the user device 210 may also include or otherwise have access to a Message Authentication Code (MAC) generator 218 that is able to generate a MAC or keyed cryptographic hash function 218A. In one embodiment, the MAC 218A may be a HMAC-SH256. The MAC generator 218 may generate the MAC 218A by taking as inputs at least the binding key 216, the PAN 212, the CVV 213, and the authentication ticket 271. In some embodiments, the public key 214 and other user 205 information such as a billing address or the like (i.e., other information 274) may also be used as inputs when generating the MAC 218A.

The user device 210 may package a payload 310 that includes the binding key token 261, the PAN token 262, the CVV token 263, and the authentication ticket 271. In those embodiments that include the public key 214, the public key 214 may also be included in the payload 310. In other embodiments, even if a public key is available, the public key 214 may not be included in the payload 310 as the public will be provided to the payment instrument service 240 at the time of requesting to export the saved PAN. The payload 310 may be signed using the MAC 218A as denoted by the dashed line 311.

The payload 310 may then be provided to the payment instrument service 240 as indicated at 315. While being provided to the payment instrument service, the payload 310 may utilize one or more of the business services 220 while being transported across the non-trusted systems/services 202. In addition, the risk/fraud services 230 may perform risk and fraud services on the authentication ticket 271. Advantageously, the business services 220 and the risk/fraud services 230 have no access to the actual PAN 212 or CVV 213 (although they may have access to subsets of the PAN that can be used to communicate with other risk system) since these are not included in the payload 310. This in part removes the need for the non-trusted systems/services 202 to be PCI compliant. Further, any risk or fraud services are only performed on the authentication ticket 271 and thus these services should not affect the other elements of the payload 310, also increasing security.

Referring now to FIG. 3C, the payload 310 may be received by the payment instruments service 240. The payment instrument service 240 may extract the binding key token 261, the PAN token 262, and the CVV token 263 from the payload 310 and may provide these tokens to the tokenization module 260 as shown at 320. The tokenization module may verify that the tokens provided by the payment instrument service match the tokens it created. In addition, the tokenization module 260 may verify that the payment instrument service 240 is included in the trusted systems/services 203. The tokenization module 260 may then provide the actual binding key 216, the PAN 212, and the CVV 213 to the payment instrument service 240 as shown at 321. Of course, if the tokenization module 260 does not verify that the tokens match or that the payment instrument service 240 is part of the trusted systems/services 203, then it will not provide the binding key 216, the PAN 212, and the CVV 213 to the payment instrument service 240. Once the binding key 216, the PAN 212, and the CVV 213 are provided to the payment instrument service 240, the tokenization module 260 may remove the binding key 216, the PAN 212, the CVV 213, binding key token 261, the PAN token 262, and the CVV token 263 from its memory to thereby decrease the possibility that these may be obtained from the tokenization module 260 by an unauthorized party.

The payment instrument service 240 may also extract the authentication ticket 271, including the user ID 272, the device ID 273, and the other information 274 and, if included, the public key 214 from the payload the 310. The payment instrument service 240 may use the binding key 216, the PAN 212, the CVV 213, the authentication ticket 271, as well as the public key 214 and the other user 205 information 274 if included, to generate a MAC 218B. Since the inputs to the MAC 218B are the same as the inputs to the MAC 218A, if the payload 310 has not been tampered with the MAC 218B should match the MAC 218A, thus verifying that the payload 310 is authentic.

For example, in some instances, as the payload 310 is being transported across the non-trusted systems/services 202, an attacker may attempt to replace the authentication ticket 271 with an authentication ticket under the attacker's control as this may cause the system 201 to give the attacker access to the PAN 212. The attacker may also attempt to replace one or more of the tokens in the payload 310 to attempt to gain access to the PAN 212 and CVV 213. Advantageously, since the attacker should have no knowledge of the binding key 216 or of the actual authentication ticket 271, any changes to the payload 310 would not be reflected in the MAC 218A. That is, when the MAC 218A is compared to the MAC 218B, the verification would fail since the MAC 218A would no longer be valid, thus showing that payload 310 had been tampered with. In such cases, the payload 310 may be rejected by the payment instrument service 240 and no access to the PAN will be granted.

In the present embodiment, the binding key 216 and the CVV 213 are used to help in MAC verification process and may therefore be removed by the payment instrument service 240 at the completion of the MAC verification. Thus, the binding key 216 and the CVV 213 are not permanently stored in the PAN store 241. This provides additional security as it decreases the chance that the binding key 216 and the CVV 213 may be obtained by an unauthorized party.

The payment instrument service 240 may cause that the PAN 212 be encrypted as denoted by the dashed line 242 and then stored in the PAN store 241. For example, in one embodiment the payment instrument service 240 may encrypt the PAN 212 using a key such as key 250A from the key store 250. The key 250A may be a service key that is provided ahead of time. Accordingly, since an unauthorized party is not likely to have a decryption key that matches the key 250A, this encryption provides strong security for the stored PAN 212.

In some embodiments, to provide additional security, the PAN 212 may also be encrypted with a second key that is associated with the user device 210 and it device ID 273. In such embodiments, the key may be a key from the key store 251 such as key 251A that was provided by the user device 210 ahead of time. In other embodiments, the second key may be provided as part of the payload 310 or in some other reasonable way. Accordingly, use of the second key provides even further security as it would be necessary to have a decryption key for the both the key 250A and 251A in order to decrypt the PAN 212. Again, it is unlikely that an unauthorized party would have access to both decryption keys.

In some embodiments, the payment instrument service 240 may validate the stored PAN 212 by providing it to a payment processor (not illustrated) that is outside the control of the payment system 201. This may be done by sending a $0 transaction along with the PAN 212, CVV 213 (before it is discarded), and billing address to the payment processor. If these values are valid, this will be reflected by the payment processor.

It will be appreciated that the process just discussed will show that the user 205 possesses the payment instrument 211 and is therefore presumably authorized to use it in financial transactions. In other words, since the user 205 was able to provide a verified authentication ticket 271 and was also able to gain access to the binding key 216, the PAN 212, and the CVV 213, there is a high confidence that the user 205 is the actual owner of the payment instrument 211. Accordingly, the payment instrument service 240 may create an association 243 in the PAN store 241 between the user ID 272 and the encrypted PAN 212. The association 243 provides proof that the user 205 is authorized to use PAN 212 and, as will be explained in more detail to follow, may be used verify a request to export the PAN 212 back to the user 210 to complete a financial transaction. In some embodiments, the association 243 may be considered as a type of Access Control List (ACL) that specifies that the user 205, because of the user ID 272, is permitted to access the encrypted PAN 212 as needed.

In some embodiments, the association 243 may include a time component 243A that records a time that the association 243 is created or updated. In this way, the payment instrument service 240 is able to ascertain if the association is still be used. If the association has not been used for a long time, the system may remove it from the PAN store 241 as a security measure.

### Enrollment Bind Device

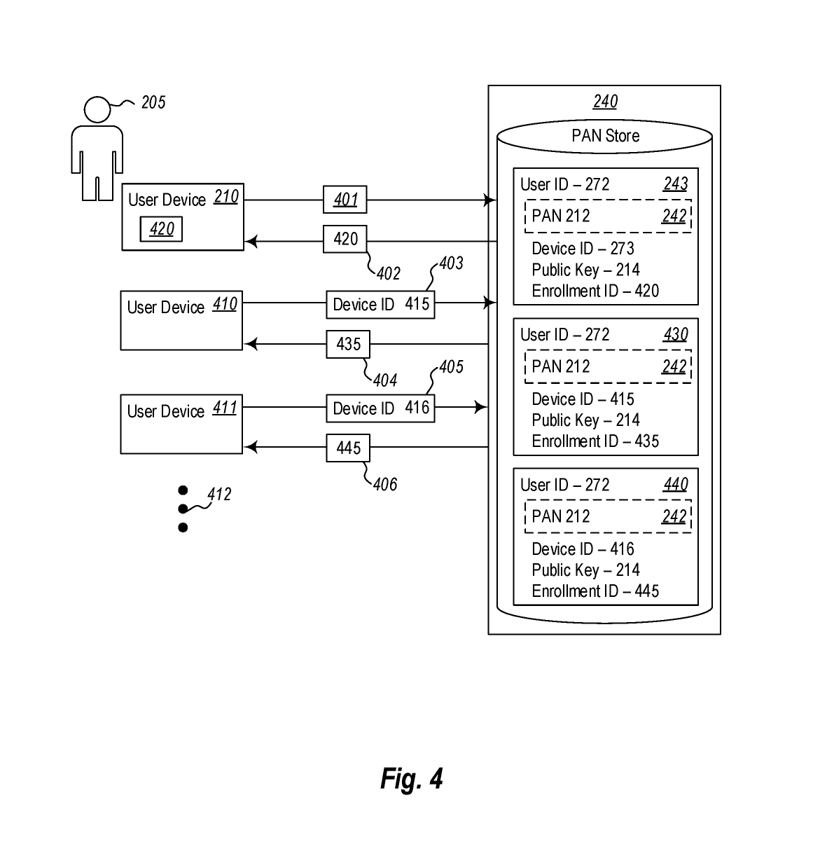

In some embodiments, as shown in FIG. 4, a second call shown at 401 to the payment instrument service 240 may be made by the user device 210 to bind the device ID 273 and the public key 214 (if present) to the user ID 272. As shown in FIG. 4, as a result of the call 401 the device ID 273 and the public key 214 are bound to the user ID 272 and are added to the association 243. Of course, adding the device ID 273 and the public key 214 to the association 243 is for ease of explanation only as in other embodiments the binding of the device ID 273 and public key 214 to the user ID 272 may generate a different association or ACL. It will be noted that in some embodiments, there need not be a second call as the functions described herein in relation to the second call 401 may be performed in response to the call to add the PAN 212 as previously described.

In some embodiments, the call 401 that bound the device ID 273 and the public key 214 to the user ID 272 will return an enrollment ID 410. The enrollment ID 420 may be a short term, cryptographically strong identifier that signifies that the device associated with the device ID 273 (i.e., user device 210) has permission to export the PAN 212. As shown at 402, the enrollment ID 420 may be returned to the user device 210 to be used as an input when an export call is made as will be explained in more detail to follow. This advantageously ensures that only a device, such as user device 210, that is recognized as being controlled by the user 205 is able to have access to the encrypted PAN 212.

As will be appreciated, it is likely that the user 205 may also use additional devices when using the payment instrument 211 to make purchases. For example, the user device 210 may be a desktop computer that is used to add the PAN 212 to the PAN store 241 in the manner previously described. The user 205, however, may also use a user device 410, which may be a smart phone, and a user device 411, which may be laptop or other mobile computing device, when using the payment instrument 211 to make purchases. The user 205 may use any number of additional devices as illustrated by ellipses 412. Accordingly, the embodiments disclosed herein allow the user 205 to also associate the devices 410 and 411 with the user ID 272 and the PAN 212 that are stored in the PAN store 241.

For example, as shown at 403 the user device 410 may make a call that provides a device ID 415 along with the user ID 272 (not shown) to show that user 205 controls device 410 to the payment instrument service 240. Of course, other information as previously described may also be provided, for example a public key that is specific to the device 410. This may be accomplished by the use of an authentication ticket, binding key, and tokenization in the manner previously described. Once received and extracted, the payment instrument service 240 may create an association or ACL 430 that binds the device ID 415 to the user ID 272, the encrypted PAN 212, and the public key 214. This binding returns as shown at 404 an enrollment ID 435, which in some embodiments may be the same as the enrollment ID 420.

In similar manner, as shown at 405 the user device 411 may make a call that provides a device ID 416 along with the user ID 272 (not shown) to show that user 205 controls device 411 to the payment instrument service 240. Of course, other information as previously described may also be provided, for example a public key that is specific to the device 411. This may be accomplished by the use of an authentication ticket, binding key, and tokenization in the manner previously described. Once received and extracted, the payment instrument service 240 may create an association or ACL 440 that binds the device ID 416 to the user ID 272, the encrypted PAN 212, and the public key 214. This binding returns as shown at 406 an enrollment ID 445, which in some embodiments may be the same as the enrollment ID 420.

It will be noted that in the embodiment shown in FIG. 4, each of the user devices 210, 410, and 411 were shown as including the public key 214. However, this need not be the case as in other embodiments each user device may have its own public key that is different from the public keys of the other devices as circumstances warrant.

It will be noted that the structure of the associations or ACLs 243, 430, and 440 shown in FIGS. 3C and 4 are for illustration only. Thus, in other embodiments, these elements may have a different structure. In addition, in some embodiments the associations 243, 430, and 440 may be combined into a single association or ACL. Accordingly, the embodiments disclosed herein are not limited by any particular structure or number for the various associations.

### Export Payment Instrument Flow

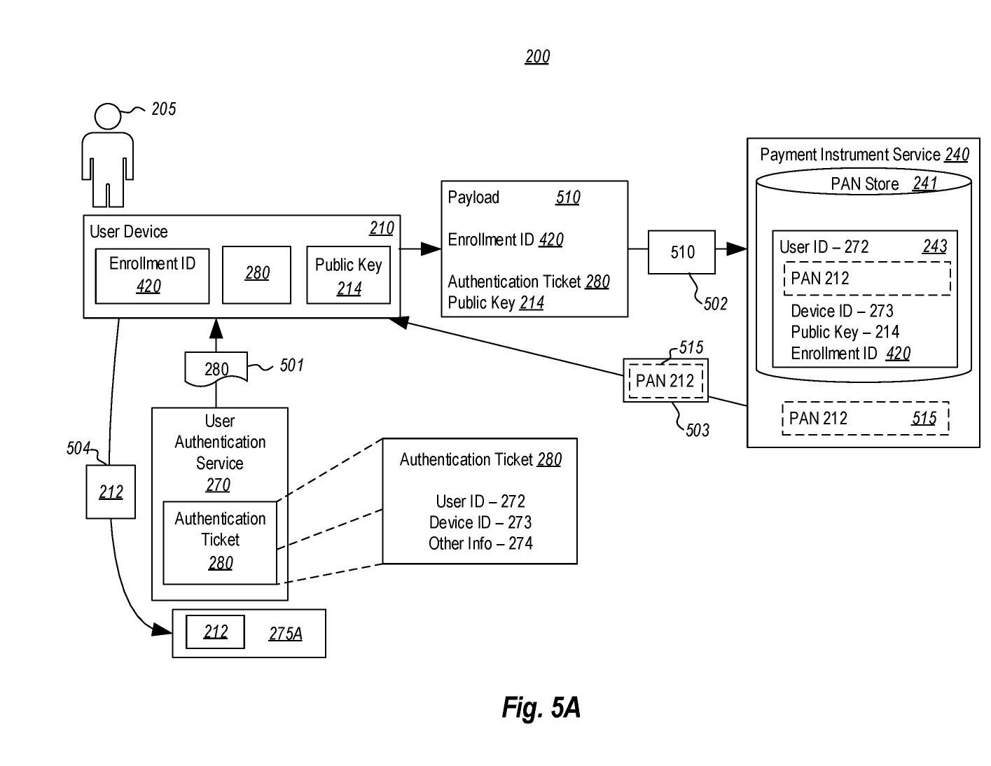

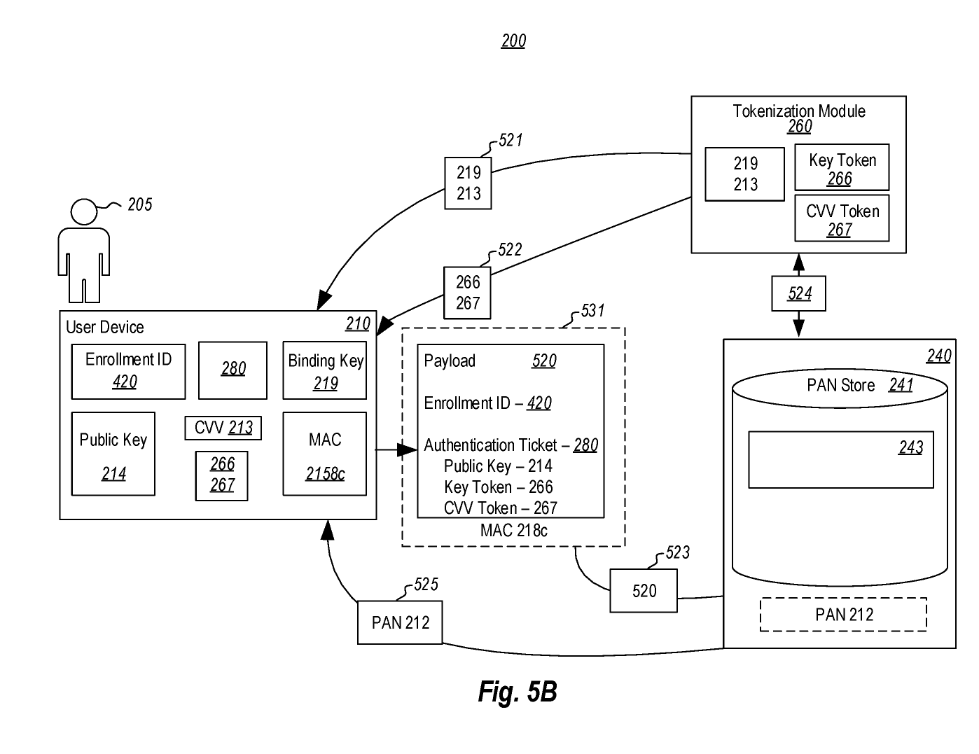

Referring now to FIG. 5A, embodiments of a flow for exporting the PAN 212 to the user device 210 will now be explained. As shown in FIG. 5A, the user authentication service 270 may generate an authentication ticket 280 as part of an authentication process to authenticate the identity of the user 205 and the user device 210. The authentication ticket 280 may include the user ID 272 such as a user name, address, or the like that identifies the user 205, the device ID 273 that identifies the user device 210, and other information 274 as needed. The authentication ticket 280 may be secured using known security methods such as Transport layer security (TLS). The authentication ticket 280 may be returned to the user device 210 as shown at 501. It will be noted that the authentication ticket 280 may be different from the authentication ticket 271 that was generated during the process of adding the PAN to the PAN store 421. Requiring a new authentication ticket when requesting to export the PAN 212 provides additional security in case the earlier authentication ticket 271 has been compromised. In addition, in some embodiments the authentication ticket 271 may have a short life span and thus may not be available at the time of export.

The user device 210 may package a payload 510 that includes the enrollment ID 410 that was returned as previously described and the authentication ticket 280. In some embodiments, where the public key 214 was not previously provided to the service 240, the payload 510 may also include the public 214. The payload 510 may then be provided to the payment instrument service 240 as shown at 502. Although not shown, the payload may be transmitted through the non-trusted systems/services 202 and may have fraud and risk services performed on it by risk/fraud services 230.

The payment instrument service 240 may extract the user ID 272, the device ID 273, and the enrollment ID 420 from the payload 510. In those embodiments where the public key 214 is also included in the payload 510, this is also extracted. The payment instrument service 240 may then search the PAN store 241 for an association or ACL that has values matching those extracted from the payload 510. In the present embodiment, the payment instrument service 240 may find that the association 243 includes values that match those extracted from the payload 510. Accordingly, the payment instrument service 240 is able to determine that the user 205 and the user device 210 are authorized to have access to the PAN 212.

The payment instrument service 240 may then use the public key 214 to encrypt the PAN 212. As mentioned previously, the public key may be provided during the process for adding the PAN to the store 241 or may be provided during the process for exporting the PAN. Since the PAN 212 is encrypted in the manner previously described while being stored in the PAN store 241, the encryption with the public key 214 may be in addition to this encryption if the user device 210 has access to a private key that is paired with the key 250A and or with the key 251A used in the previous encryption or the service 240 may decrypt the PAN 212 from the earlier encryption and then only re-encrypt using only the public key 214. The encryption using the public key 214 is represented by the dashed lines 515.

In one embodiment, where the PAN 212 is encrypted with the both the public key 214 and the key 250A as previously discussed, it may be advantageous from a security viewpoint to have the private key 215 located on one of the user device 210 or the third party provider 275A and have the decryption or private key paired with the encryption key 250A on the other of the user device or third party provider. In this way, each system in the process will check to see if there has been any security issues. If one of the systems determines that there has been a security issue, then the PAN 212 may not be used further on that path. It will be noted that the PAN 212 may be encrypted with as many keys as wanted and each decryption key may be located on any number of systems, thus providing additional security.

In one embodiment where multiple private keys are distributed on multiple devices, it may be possible to set a threshold for the number of decryptions that should occur for the process to be valid. For example, suppose that five systems each included a private key. The payment system 201 could specify that as long as four of the five systems were able use their private keys to aid in the decryption process, the process would be valid. Thus, one of the systems need not participate. However, if more than one system did not patriciate so that less than four system participated, the system would deem the process invalid. This process could be helpful in the situation where the user 205 had lost a password. If the user 205 is able to have enough of the machines that are used in the process, for example enough of the third party providers, provide their private keys to the payment system 201, this may cause the system 201 to infer that the user 201 is actually authorized to access the PAN 212.

Returning to FIG. 5A, as shown at 503, the payment instrument service 240 may return the encrypted PAN 212 to the user device 212. Although not shown, the encrypted PAN 212 may be transmitted through the non-trusted systems/services 202 and may have fraud and risk services performed on it by risk/fraud services 230.

The encrypted PAN 212 may then be decrypted by use of either the private key 215 and/or the private key 276 (FIG. 3A) that are paired with the public key 214. As shown at 504, the PAN 212 may be provided to the third party provider 275A to complete the financial transaction.

FIG. 5B illustrates an alternative embodiment of a flow for exporting the PAN 212 to the user device 210. The embodiment of FIG. 5B is similar to that of the embodiment of FIG. 5A, except that the embodiment of FIG. 5B includes the use of crypto-binding using tokenization in the manner previously described. Although not illustrated in FIG. 5B, the user authentication service 270 may generate the authentication ticket 280 as part of an authentication process to authenticate the identity of the user 205 and the user device 210 and may return the authentication ticket to the user device as shown in FIG. 5A.

For example, the user device may generate a binding key 219 that is not known to any other system or service. Since the binding key 216 generated during the add process was a one-time use key, it is necessary to generate a new binding key at the time of export. The binding key 219 may be an ephemeral (i.e., short term, one time use), random, cryptographically strong, symmetric key, minimum of 128 bits long. In other embodiments other reasonable binding keys may be generated as circumstances warrant.

As shown at 521, the user device 210 may send the binding key 219 and the CVV 213 to the tokenization module 260. The tokenization module 260 stores the binding key 219 and CVV 213 and also generates key token 266 and CVV token 267. The tokens may be sent back to the user device 267 as shown at 522.

The user device 210 may also include or otherwise have access to the MAC generator 218 (FIG. 3B) that is able to generate a MAC or keyed cryptographic hash function 218C. In one embodiment, the MAC 218C may be a HMAC-SH256. The MAC generator 218 may generate the MAC 218C by taking as inputs at least the binding key 219, the CVV 213, and the authentication ticket 280. In some embodiments, the public key 214 and other user 205 information such as a billing address or the like (i.e., other information 274) may also be used as inputs when generating the MAC 218C.

The user device 210 may package a payload 520 that includes the enrollment ID 410 that was returned as previously described, the authentication ticket 280, the key token 266, and the CVV token 267. In some embodiments, where the public key 214 was not previously provided to the service 240, the payload 520 may also include the public 214. The payload 520 may be signed using the MAC 218C as denoted by the dashed line 531.

The payload 510 may then be provided to the payment instrument service 240 as shown at 502. Although not shown, the payload may be transmitted through the non-trusted systems/services 202 and may have fraud and risk services performed on it by risk/fraud services 230.

The payment instrument service 240 may extract the key token 266 and the CVV token 267 and may provide them to the tokenization module 260 as shown at 524. Since these token match the tokens stored in module 260, the binding key 219 and the CVV 213 are returned to the payment instrument service 240 as also shown at 524.

The payment instrument service 240 may use the binding key 219, the CVV 213, the authentication ticket 280, as well as the public key 214 and the other user 205 information 274 if included, to generate a MAC 218D. Since the inputs to the MAC 218C are the same as the inputs to the MAC 218D, if the payload 520 has not been tampered with the MAC 218D should match the MAC 218C, thus verifying that the payload 520 is authentic.

The payment instrument service 240 may also extract the user ID 272, the device ID 273, and the enrollment ID 420 from the payload 520. In those embodiments where the public key 214 is also included in the payload 520, this is also extracted. The payment instrument service 240 may then search the PAN store 241 for an association or ACL that has values matching those extracted from the payload 520. In the present embodiment, the payment instrument service 240 may find that the association 243 includes values that match those extracted from the payload 520. Accordingly, the payment instrument service 240 is able to determine that the user 205 and the user device 210 are authorized to have access to the PAN 212.

The payment instrument service 240 may then use the public key 214 to encrypt the PAN 212. As mentioned previously, the public key may be provided during the process for adding the PAN to the store 241 or may be provided during the process for exporting the PAN. Since the PAN 212 is encrypted in the manner previously described while being stored in the PAN store 241, the encryption with the public key 214 may be in addition to this encryption if the user device 210 has access to a private key that is paired with the key 250A used in the previous encryption or the service 240 may decrypt the PAN 212 from the earlier encryption and then only re-encrypt using only the public key 214. The encryption using the public key 214 is represented by the dashed lines 515.

In those embodiments where no public key is provided by the user device 210, either during process for adding the PAN or exporting the PAN, then the binding key 219 may be used to encrypt the PAN 212. Since the user device 210 also has a copy of the binding key 219, this may be used as the decryption key by the user device.

As shown at 525, the payment instrument service 240 may return the encrypted PAN 212 to the user device 212. Although not shown, the encrypted PAN 212 may be transmitted through the non-trusted systems/services 202 and may have fraud and risk services performed on it by risk/fraud services 230. The encrypted PAN 212 may then be decrypted by use of either the private key 215 and/or the private key 276 (FIG. 3A) that are paired with the public key 214. The PAN 212 may be provided to the third party provider 275A to complete the financial transaction.

In some instances, there may be instances where the private key 215 and/or the private key 276 (or some other private key that may be used in the process) has been compromised by an unauthorized party who may use the private key for a malicious purpose such as trying to steal the PAN 212. In many cases, the user 205 may not be aware that the private keys have been compromised. In such cases, there may be security risks to continuously use the public key 214 that has been stored PAN store 241to encrypt the PAN 212 because the authorized user has access to one or more of the private keys.

Accordingly, to protect against the situation where one or more of the private keys become unknowingly compromised, the user 205 may cause that for each export request, a new public key 214 should be provided to the payment instrument service 240. In such case, the user device 210 would have to also generate a new private key 215 to match the new public key 214 being used. Thus, even if the previous private key 215 were compromised, it would not be able to be used to steal the PAN 212 in future transactions.

In an alternative embodiment, a new public key 214 need not be provided for each export request. Rather, a limited use public key 214 may be stored in the PAN store 241. The limited use public key 214 may only be useable for a certain count of transactions, such as three times. At the end of the specified count, a new public key would be required. In some embodiments, the limited use may be determined by an amount of time that has passed. In other embodiments, the use of the public key may be limited based on a risk assessment so that when there is a high security risk to the system, a new public key may be required.

In still another embodiment, the user device 210 may generate a new key pair that is used to generate a signature. One of the key pair for the signature may be stored in the PAN store 241, while the other is kept at the user device 210. When an export request is made, a signature is included with the request. If any of the keys at the user device 210 have been compromised, the signature will not be verified by the key at the PAN store and thus the stored public key 214 will not be used. However, if the signatures match, then there is confidence that the private key 215 has not been compromised and the stored public key 214 can be used.

In a further embodiment, the public key 214 that is stored at the PAN store 241 and the private key 215 may not be an encryption keys, but rather may be a signature keys. For each export request, a new private and public encryption key pair may be generated and may then be signed by the private key 215. The stored public key 214 may then be used to verify the signature. If the private key 215 has been compromised, then the signature should not match. In such case, the payment instrument service 240 may not use the new key pair that was provided to ensure that no unauthorized party is able to access the PAN 212.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

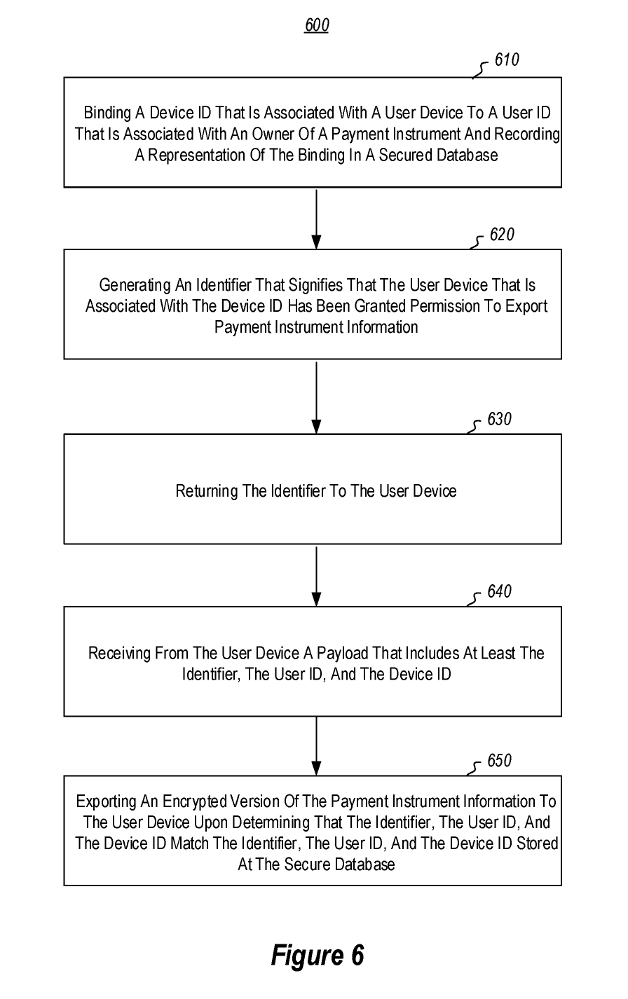

FIG. 6 illustrates a flow chart of an example method 600 for exporting a payment instrument from a secured database to a user device that is controlled by an owner of the payment instrument based on a binding between the user device and an identifier associated with the owner of the payment instrument at the secured database. The method 600 will be described with respect to one or more of FIGS. 2-5 discussed previously.

The method 600 includes binding a device ID that is associated with a user device to a user ID that is associated with an owner of a payment instrument and recording a representation of the binding in a secured database (act 610). For example, as previously described the payment instrument service 240 may bind the device ID 273 that is associated with the user device 210 to the user ID 272 that is associated with the user 205 who owns the payment instrument 211. The binding may occur in response to the call 401, although this is not required. The binding may then be recorded in the PAN store 241 as part of the association 243.

In other embodiments as previously described, the payment instrument service 240 may bind the device ID 415 associated with the device 410 to the user ID 272. The binding may then be recorded in the PAN store 241 as part of the association 430. Likewise, the payment instrument service 240 may bind the device ID 416 associated with the device 411 to the user ID 272. The binding may then be recorded in the PAN store 241 as part of the association 440.

The method 600 includes generating an identifier that signifies that the user device that is associated with the device ID has been granted permission to export payment instrument information (act 620). The payment instrument information is associated with the user ID in the secured database. For example, as previously described the payment instrument service 240 may generate the enrollment ID 420 that signifies that the user 210 has been granted permission to export the payment instrument information such as the encrypted PAN 212 stored in the PAN store 241. As previously described, the payment instrument information is associated with the user ID 272 as part of the association 243. In some embodiments, the enrollment IDs 435 and 445 may be generated in the manner previously described.

The method 600 includes returning the identifier to the user device (act 630). For example, as previously described the enrollment ID 420 may be returned to the user device 210. In some embodiments, the enrollment IDs 435 and 445 may be returned to the user devices 410 and 411 respectively.

The method 600 includes receiving from the user device a payload that includes at least the identifier, the user ID, and the device ID (act 640). For example, as previously described, the user device 210 may generate or package the payload 510 that includes the enrollment ID 420. In addition, the payload may include the user ID 272 and the device ID 273, that may be part of the authentication ticket 280. In some embodiments, the payload 510 may include the public key 214 and other information 274, although this is not required. The payload 510 may then be received by the payment instrument service 240.

The method 600 includes exporting an encrypted version of the payment instrument information to the user device upon determining that the identifier, the user ID, and the device ID match the identifier, the user ID, and the device ID stored at the secure database (act 650). For example, as previously described the payment instrument service 240 may extract the user ID 272, the device ID 273, and the enrollment ID 420 from the payload 510. The payment instrument service 240 may find that the association 243 includes values that match those extracted from the payload 510 and thus be able to determine that the user 205 and the user device 210 are authorized to have access to the encrypted PAN 212. The payment instrument service 240 may then provide the encrypted PAN to the user device 210 in the manner previously described.

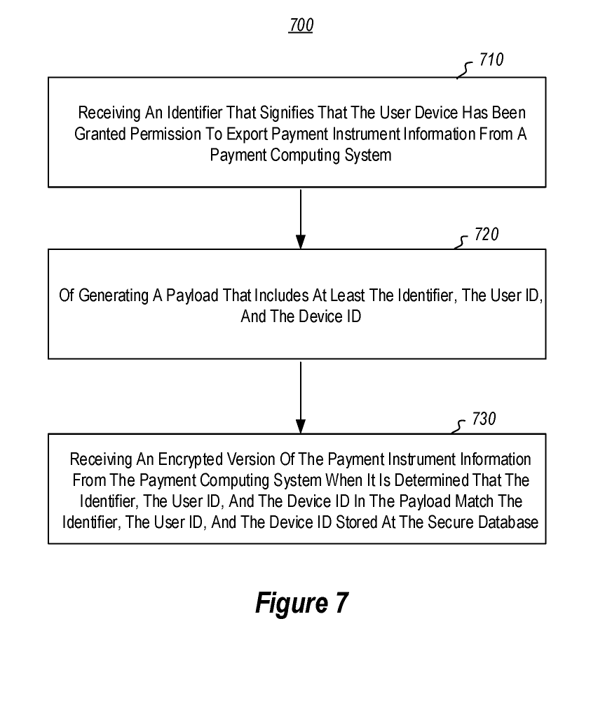

FIG. 7 illustrates a flow chart of an example method 700 for a user device to communicate with a payment computing system for exporting an encrypted payment instrument when the user device is outside the control of the payment computing system. The method 700 will be described with respect to one or more of FIGS. 2-5 discussed previously.

The method 700 includes receiving an identifier that signifies that the user device has been granted permission to export the payment instrument information from the payment computing system (act 710). The payment instrument information is associated with a user ID and a user device ID in a secured database of the payment computing system. For example, as previously described the user device 210 may receive the enrollment ID 420 from the payment instrument service 240. The enrollment ID 420 may signify that the user device 210 has permission to export the encrypted PAN 212 that is associated with the user ID 272 and the device ID 273 as part of the association 243 in the PAN store 241.

The method 700 includes generating a payload that includes at least the identifier, the user ID, and the device ID (act 720). For example, as previously described, the user device 210 may generate or package the payload 510 that includes the enrollment ID 420. In addition, the payload may include the user ID 272 and the device ID 273, that may be part of the authentication ticket 280. In some embodiments, the payload 510 may include the public key 214 and other information 274, although this is not required. The payload 510 may then be received by the payment instrument service 240.

The method 700 includes receiving an encrypted version of the payment instrument information from the payment computing system when it is determined that the identifier, the user ID, and the device ID in the payload match the identifier, the user ID, and the device ID stored at the secure database (act 730). For example, as previously described the payment instrument service 240 may extract the user ID 272, the device ID 273, and the enrollment ID 420 from the payload 510. The payment instrument service 240 may find that the association 243 includes values that match those extracted from the payload 510 and thus be able to determine that the user 205 and the user device 210 are authorized to have access to the encrypted PAN 212. The payment instrument service 240 may then provide the encrypted PAN to the user device 210 in the manner previously described.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system for implementing a mechanism to export a payment instrument from a secured database to a user device that is controlled by an owner of the payment instrument based on a binding between the user device and an identifier associated with the owner of the payment instrument at the secured database, the computing system comprising:
at least one processor;
system memory having stored thereon computer-executable instructions which, when executed by the at least one processor, cause the computing system to perform the following:
an act of binding a device ID that is associated with a user device to a user ID that is associated with an owner of a payment instrument and recording a representation of the binding in a secured database;
an act of generating an identifier that signifies that the user device that is associated with the device ID has been granted permission to export payment instrument information, wherein the payment instrument information is associated with the user ID in the secured database;
an act of returning the identifier to the user device;
an act of receiving from the user device a payload that includes at least the identifier, the user ID, and the device ID; and
an act of exporting an encrypted version of the payment instrument information to the user device upon determining that the identifier, the user ID, and the device ID match the identifier, the user ID, and the device ID stored at the secure database.

2. The computing system according to claim 1, wherein the payload further includes a public encryption key, wherein the public encryption key is used to encrypt the payment instrument information.

3. The computing system according to claim 3, wherein the payment instrument information is further encrypted by one or more additional encryption keys.

4. The computing system according to claim 3, wherein the public encryption key is one of a limited use public encryption key that is configured to be used for a specified amount of times before being discarded or a public key used to create a digital signature.

5. The computing system according to claim 1, wherein the payment instrument information includes one or more of a Primary Account Number (PAN), a Card Verification Value (CVV), and verification information.

6. The computing system according to claim 1, wherein the payment instrument is a one of a credit card or a debit card.

7. The computing system according to claim 1, wherein the payload is signed using a message authentication code that is generated by using a tokenization process and a binding key generated at the user device.

8. A method for exporting a payment instrument from a secured database to a user device that is controlled by an owner of the payment instrument based on a binding between the user device and an identifier associated with the owner of the payment instrument at the secured database, the method comprising:
an act of binding a device ID that is associated with a user device to a user ID that is associated with an owner of a payment instrument and recording a representation of the binding in a secured database;
an act of generating an identifier that signifies that the user device that is associated with the device ID has been granted permission to export the payment instrument information, wherein the payment instrument information is associated with user ID in the secured database;
an act of returning the identifier to the user device;
an act of receiving from the user device a payload that includes at least the identifier, the user ID, and the device ID; and
an act of exporting an encrypted version of the payment instrument information to the user device upon determining that the identifier, the user ID, and the device ID match the identifier, the user ID, and the device ID stored at the secure database.

9. The method according to claim 8, wherein the payload further includes a public encryption key, wherein the public encryption key is used to encrypt the payment instrument information.

10. The method according to claim 9, wherein the payment instrument information is further encrypted by one or more additional encryption keys.

11. The method according to claim 9, wherein the public encryption key is one of a limited use public encryption key that is configured to be used for a specified amount of times before being discarded or a public key used to create a digital signature.

12. The method according to claim 8, wherein the payment instrument information includes one or more of a Primary Account Number (PAN), a Card Verification Value (CVV), and other verification information.

13. The method according to claim 8, wherein the payment instrument is a one of a credit card, a debit card, or a bank account.

14. The method according to claim 8, wherein the payload is signed using a message authentication code that is generated by using a tokenization process and a binding key generated at the user device.

15. A user device that communicates with a payment computing system for exporting an encrypted payment instrument, the user device being beyond the control of the payment computing system, the user device comprising:
at least one processor;
system memory having stored thereon computer-executable instructions which, when executed by the at least one processor, cause the user device to perform the following:
an act of receiving an identifier that signifies that the user device has been granted permission to export payment instrument information from a payment computing system, wherein the payment instrument information is associated with a user ID and a user device ID in a secured database of the payment computing system;
an act of generating a payload that includes at least the identifier, the user ID, and the device ID; and
an act of receiving an encrypted version of the payment instrument information from the payment computing system when it is determined that the identifier, the user ID, and the device ID in the payload match the identifier, the user ID, and the device ID stored at the secure database.

16. The user device according to claim 15, wherein the payload further includes a public encryption key, wherein the public encryption key is used by the payment computing system to encrypt the payment instrument information.

17. The user device according to claim 16, wherein the public encryption key is one of a limited use public encryption key that is configured to be used for a specified amount of times before being discarded or a public key used to create a digital signature.

18. The user device according to claim 15, wherein the payment instrument information includes one or more of a Primary Account Number (PAN), a Card Verification Value (CVV), and other verification information.

19. The user device according to claim 15, wherein the payment instrument is a one of a credit card, a debit card, or a bank account.

20. The user device according to claim 15, wherein the payload is signed using a message authentication code that is generated by using a tokenization process and a binding key generated by the user device.
